(19) United States
(12) Patent Application Publication
(10) Pub. No.: US 2015/0121890 A1
(43) Pub. Date: May 7, 2015

(54) HIGH VELOCITY COMBUSTOR

(71) Applicants: Joseph Colannino, Bellevue, WA (US); Robert E. Breidenthal, Seattle, WA (US); Igor A. Krichtafovich, Kirkland, WA (US)

(72) Inventors: Joseph Colannino, Bellevue, WA (US); Robert E. Breidenthal, Seattle, WA (US); Igor A. Krichtafovich, Kirkland, WA (US)

(73) Assignee: CLEARSIGN COMBUSTION CORPORATION, SEATTLE, WA (US)

(21) Appl. No.: 14/397,549

(22) PCT Filed: Apr. 30, 2013
(86) PCT No.: PCT/US2013/038931

§ 371 Date: Oct. 28, 2014

Related U.S. Application Data
(60) Provisional application No. 61/640,692, filed on Apr. 30, 2012.

(51) Int. Cl. F23C 99/00; F02C 3/20; F23R 3/42

(52) U.S. Cl. CPC F23C 99/001; F23R 3/42; F02C 3/20
USPC 60/772; 431/253; 431/2

(57) ABSTRACT

A combustor provides reaction anchoring by injecting a voltage or charge into an exothermic reaction such as aflame, and anchoring the exothermic reaction to a conductive surface positioned adjacent to a fuel jet nozzle.

### CROSS-REFERENCE TO RELATED APPLICATIONS

The present application claims priority benefit from U.S. Provisional Patent Application No. 61/640,692, entitled “HIGH VELOCITY COMBUSTOR”, filed Apr. 30, 2012, which to the extent not inconsistent with the disclosure herein, is incorporated by reference.

### SUMMARY

According to an embodiment, a fuel combustor includes an electrically conductive surface configured to be positioned adjacent to or within a fuel jet. An electrode is configured to apply a voltage to an exothermic reaction supported by the fuel jet. A voltage or charges imparted on the exothermic reaction by the electrode causes the exothermic reaction to anchor to the electrically conductive surface.

According to another embodiment, a method for operating a high velocity combustor includes emitting a jet of fuel from a nozzle, igniting the fuel, and applying a voltage waveform to the ignited fuel with an electrode located distal from the nozzle. An electric charge or voltage is transmitted along the jet of fuel from the electrode to an electrically conductive surface located proximate to or coextensive with the nozzle. The electric charge or voltage transmitted along the jet of fuel acts to anchor the ignited combustion reaction to the electrically conductive surface.

### BRIEF DESCRIPTION OF THE DRAWINGS

FIG. 1 is a diagram of a high-velocity combustor configured to anchor an exothermic reaction such as a combustion reaction or flame to an electrically conductive surface, according to an embodiment.

FIG. 2 is a diagram of a high-velocity combustor configured to anchor a flame to an electrically conductive surface, according to another embodiment.

FIG. 3 is a diagram of a gas turbine including a high velocity combustor, according to an embodiment.

FIG. 4 is a flow chart illustrating a method for using the high-velocity combustor of FIGS. 1-3, according to an embodiment.

FIGS. 5 and 6 are derived from photographic images taken of a flame supported by a high-velocity fuel jet in an experimental test, according to an embodiment. FIG. 5 is a depiction of an experimental condition in which no voltage is applied to the flame, while FIG. 6 is a depiction of an experimental condition in which a voltage potential is applied, via an electrode, to the flame, and causing the flame to be anchored to the conductive surface of the fuel let nozzle, according to embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

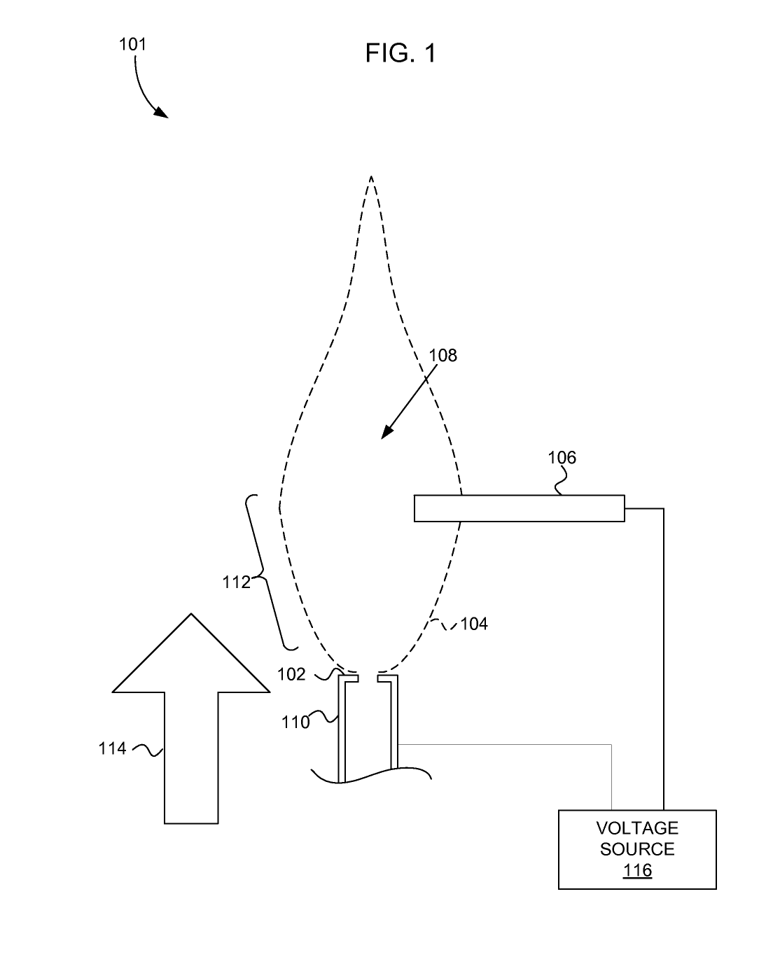

FIG. 1 is a diagram of a high-velocity combustor 101 configured to anchor an exothermic reaction 108 to an electrically conductive surface 102, according to an embodiment. The electrically conductive surface 102 can be positioned adjacent to or within a fuel jet 104 emitted from a fuel nozzle 110. In the embodiment of FIG. 1, the conductive surface 102 is positioned on a portion of the nozzle 110 adjacent to the orifice from which the fuel jet 104 is emitted. The electrode 106 is configured to apply a voltage or charge to the exothermic reaction 108. In the present disclosure, the exothermic reaction 108 is represented as a flame, but can also include other types of exothermic and combustion reactions. In other embodiments, the reaction 108 can be replaced by another reaction that is not exothermic, but which produces ions. The presence of the ions, and particularly ions having a mass greater than an electron, can be conducive to producing the types of voltage-based holding forces disclosed herein.

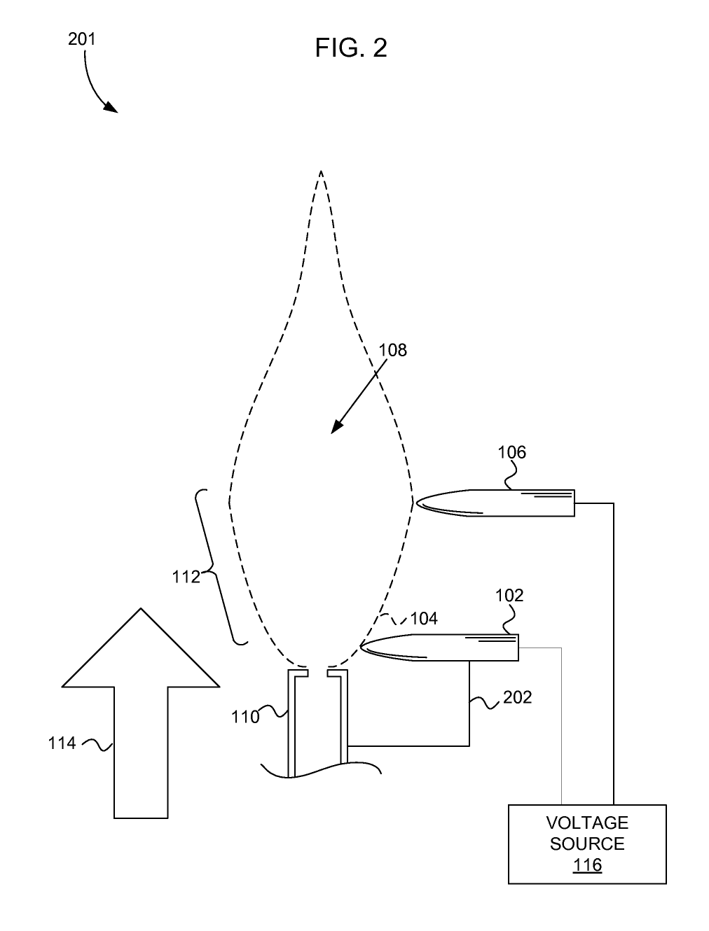

The electrode 106 is configured to interact with the exothermic reaction 108. The electrode 106 is positioned for at least intermittent contact with the exothermic reaction 108. The electrically conductive surface 102 may be coextensive with, or a part of the fuel nozzle 110. Alternatively, as shown, for example, in FIG. 2, the electrically conductive surface 102 can be separate from the fuel nozzle 110. A voltage source 116 is operatively coupled to the electrode 106 and the conductive surface 102.

FIG. 2 is a view of a high velocity combustor 201 according to another embodiment. As shown in FIG. 2, the electrically conductive surface 102 can be positioned separate from the fuel nozzle 110. The electrically conductive surface 102 is in at least intermittent contact with the fuel jet 104, or alternatively may be disposed adjacent to the fuel jet 104. The electrically conductive surface 102 and fuel nozzle 110 can be operatively coupled by an electrical connection 202 configured to maintain the electrically conductive surface 102 and the fuel nozzle 110 at substantially the same electrical potential, as shown in FIG. 2. Alternatively, the electrically conductive surface 102 can be separated from the fuel nozzle 110 and not in electrical continuity with the fuel nozzle 110. Thus, according to some embodiments, the electrical connection 202 may be omitted.

In experiments configured in accordance with various embodiments, it was found that the application of a voltage to a flame 108 caused the flame 108 to anchor to the electrically conductive surface 102. Removal of the voltage caused the flame to anchor to a bluff body positioned above the electrically conductive surface 102. The experiment was repeated several times and the result was found to be consistent. Under conditions that were substantially identical except for the presence or absence of a voltage applied to flame, anchoring of the flame 108 to the electrically conductive surface 102 in the presence of an applied voltage was observed even when the velocity of the fuel jet 104 was greater than the flame propagation velocity in the absence of an applied voltage. The anchoring phenomenon described herein may also be referred to as “flame holding” (for cases where the exothermic reaction includes a flame).

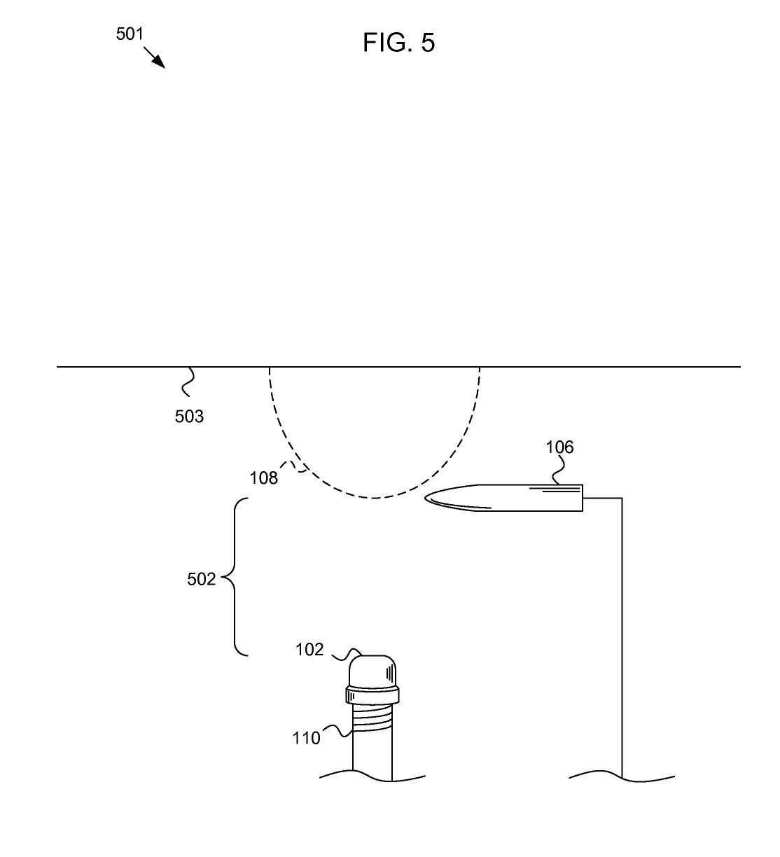

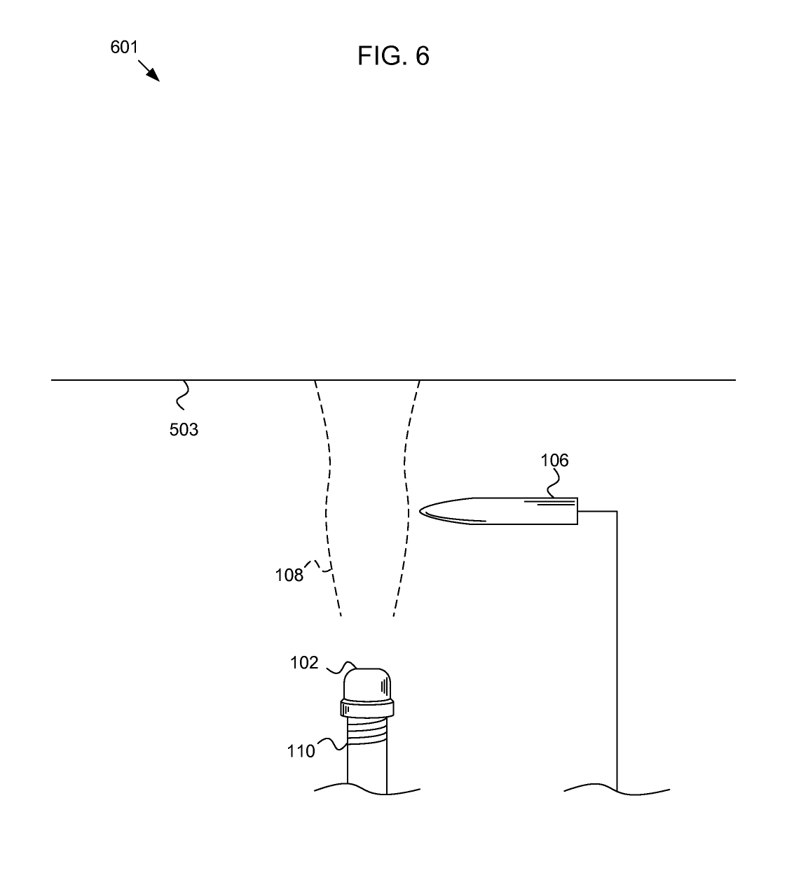

FIGS. 5 and 6 are derived from photographic images taken during experimental tests like those referred to above. The tests were conducted using a high-velocity combustor system 501 that included a nozzle 110 configured to emit a fuel jet (not visible in FIGS. 5 and 6) at a selected velocity, and to support a combustion reaction 108—specifically, in the experiments depicted, a flame. The nozzle 110 included an electrically conductive outer surface portion 102. A bluff body 503 was positioned over a central axis of the nozzle 110 so that a fuel jet emitted from the nozzle, and/or a combustion reaction 108 supported by the fuel jet would impinge on a proximal face of the bluff body. An electrode 106 was positioned so as to apply a voltage to one or both of the fuel jet and the combustion reaction. Although not shown in FIGS. 5 and 6, a voltage source was also provided, configured to apply a voltage difference to the electrode 106 and the conductive surface 102.

FIG. 5 is a depiction of an experimental condition in which no voltage was applied to the flame 108. The velocity of the fuel jet as it exited the nozzle 110 significantly exceeded the flame propagation velocity under those conditions, so that the flame 108 exhibited “lift off” 502, i.e., the flame 108 separated from a stable position over the conductive surface 102 and was in an unstable position. Flame “lift off” 502 may generally be undesirable and may indicate a combustion condition where the flame 108 is prone to blow-out. Blow-out can result in unburned fuel streaming into a combustion space. This can be a dangerous condition.

FIG. 6 is a depiction of an experimental condition with in which voltage was applied to the flame 108, substantially as described with reference to previously disclosed embodiments, resulting in the flame 108 being anchored to the conductive surface 102. The anchoring was characterized by a luminous and/or plasma state extending substantially to the conductive surface 102. In the depiction of FIG. 6, a small separation is shown between the body of the flame 108 and the conductive surface 102. However, in the original photographs, one may see fine luminous tendrils extending from the main body of the flame 108 to the conductive surface 102. The test conditions, including the velocity of the fuel jet, in the test segments depicted in FIGS. 5 and 6 were identical, except for the presence or absence of a voltage potential applied to the flame 108. Thus, the difference in flame position and anchoring was due to the voltage applied to the electrode, and from the electrode to the flame 108.

The voltage applied to the exothermic reaction 108 was observed to cause luminous emissions to form along a portion 112 of the fuel jet 104 between the electrode 106 and the electrically conductive surface 102. It is theorized that the emissions noted between the electrode 106 and the conductive surface 102, may be plasma emissions, and that the plasma emissions may continuously ignite the exothermic reaction 108.

During the experiments described above, the luminous emissions appeared when the voltage was applied to the electrode 106 (and the flame 108 was anchored to the conductive surface 102), and disappeared when the voltage was removed (and the flame 108 was blown off the conductive surface 102).

Referring again to FIGS. 1 and 2, in an embodiment, the electrode 106 and the electrically conductive surface 102 are configured for placement in a gas stream 114 having a velocity greater than the flame propagation velocity along the fuel jet 104.

A voltage source 116 is operatively coupled to the electrode 106 and optionally to the conductive surface 102. The voltage source 116 provides to the electrode 106 a voltage selected to cause the exothermic reaction 108 to anchor to the conductive surface 102. A variety of voltage outputs from voltage source 116 are contemplated. According to an embodiment, the voltage source 116 is configured to apply a time-varying voltage to the electrode 106. For example, the voltage may include an alternating current voltage.

The time-varying voltage may include a periodic voltage waveform having for example, 0.5 Hertz to 10,000 Hertz frequency. According to some embodiments, the time-varying voltage includes a periodic voltage waveform having a 100 Hertz to 1000 Hertz frequency. The time-varying voltage may include, for example, a square waveform, sine waveform, triangular waveform, truncated triangular waveform, sawtooth waveform, logarithmic waveform, exponential waveform, or non-symmetric waveforms. The time-varying voltage may include a waveform having ±1000 volt to ±115,000 volt amplitude. According to various embodiments, the time-varying voltage includes a waveform having ±8000 volt to ±50,000 volt amplitude. According to an embodiment, a DC offset voltage is included with a time-varying voltage.

The voltage source 116 is configured to maintain the electrically conductive surface 102 at a voltage different than the voltage applied to the electrode 106. This different voltage may be substantially ground potential, or may be a time-varying voltage opposite in polarity to the time-varying voltage applied to the electrode 106. According to an embodiment, the electrically conductive surface 102 is electrically isolated from ground and from voltages or power sources other than the voltage supplied by the voltage source 116 and applied to the exothermic reaction 108 by the electrode 106.

Electrode 106 and/or electrically conductive surface 102 may optionally include sharp or dull electrodes.

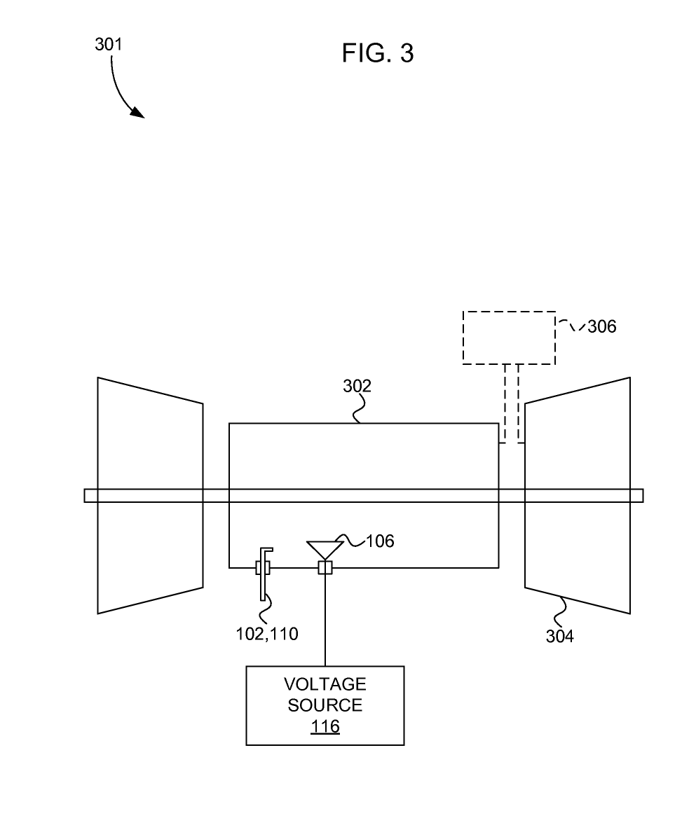

Fuel combustors are used for many purposes, including supplying heat to industrial processes, and/or generating hot gas to drive turbines. FIG. 3 diagrammatically depicts a terrestrial or aviation gas turbine 301 incorporating a high velocity combustor 302, according to an embodiment. A turbine stage 304 receives high velocity hot gas from the high velocity combustor 302, causing a turbine rotor to rotate. The turbine 301 may optionally include a topping apparatus 306 to remove heat from the hot gas prior to admitting it to the turbine stage 304.

One potential advantage of the disclosed embodiments is that a combustor incorporating the flame holding described herein may be of a smaller size than a conventional combustor, thereby reducing the overall space requirements. Another possible advantage is that, in applications where demands on an existing combustion system have increased beyond that system's output capacity, it may be possible to retrofit the existing system in accordance with the principles disclosed herein, and thereby enable an increased thermal output without requiring a new combustor.

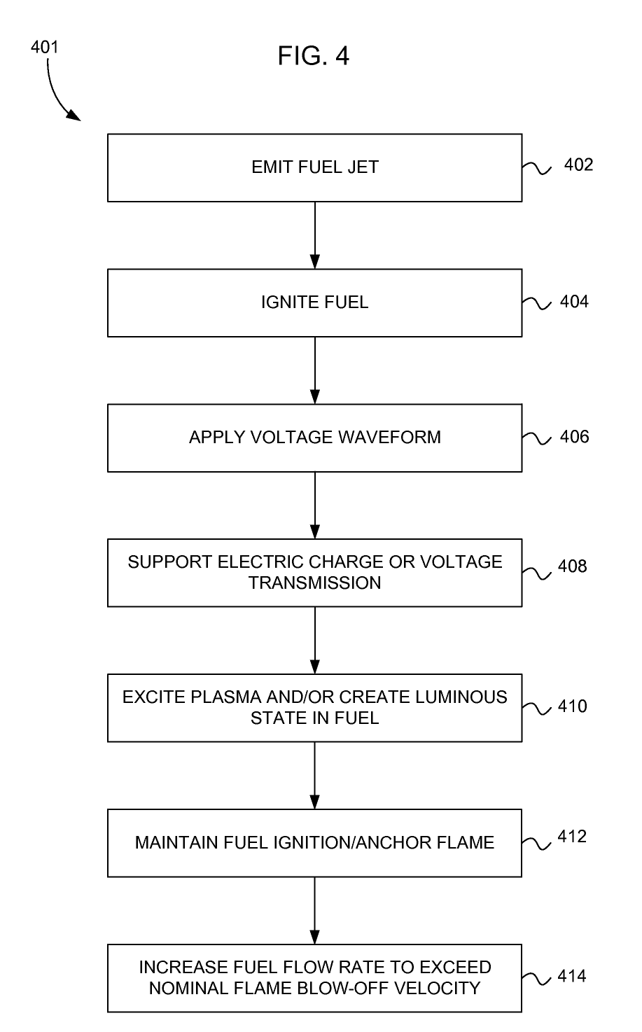

FIG. 4 is a flowchart illustrating a method 401 for operating a high velocity combustor, according to an embodiment. The method 401 begins with step 402, in which a jet of fuel is emitted from a nozzle. In step 404, the fuel is ignited. Proceeding to step 406, a voltage waveform is applied to the ignited fuel. For example, the voltage waveform may be applied to the ignited fuel with an electrode located distal from the nozzle. Proceeding to step 408, an electric charge or voltage is transmitted along the jet of fuel from the electrode to an electrically conductive surface located proximate to or coextensive with the nozzle. The electrically conductive surface is maintained at a different voltage than that applied to the ignited fuel.

In step 410, a plasma state is excited in the fuel jet with the electric charge or voltage transmission. Proceeding to step 412, fuel ignition is maintained with the plasma state.

According to an alternate interpretation, step 410, includes creating a luminous state in the fuel jet with the electric charge or voltage transmission. The method then proceeds to step 412 wherein the ignition is anchored to the electrically conductive surface while ignition of the fuel jet is maintained.

Step 412 may include maintaining a flame front with the electric charge or voltage transmission. According to embodiments, the flame front may have a higher velocity than another flame front velocity absent the electric charge or voltage transmission along the jet of fuel from the electrode to the electrically conductive surface located proximate to or coextensive to the nozzle.

The method 401 then proceeds to step 414. Step 414 includes, while anchoring the flame to the electrically conductive surface, increasing fuel flow rate to exceed a fuel jet velocity at which flame blow-off occurs absent the electric charge or voltage transmission.

In addition to the method steps shown, the method 401 can, according to various embodiments, include driving a turbine with gas heated by the ignited fuel, or heating an industrial process with the ignited fuel.

Various combinations of electrodes and conductive surfaces are contemplated. For example, applying a voltage waveform in step 406 may include applying the voltage waveform with an electrode including a sharp electrode. A sharp electrode may be defined as an ion-injecting or ionizing electrode. An example of a sharp electrode is a corona electrode. Alternatively, applying a voltage waveform in step 406 may include applying the voltage waveform with an electrode including a dull electrode. A dull electrode may be defined as a non-ionizing electrode, or electrode that does not inject ions. Dull electrodes generally include smooth surfaces that do not create sufficiently high field strengths to cause ion formation by charge separation. Similarly, the electrically conductive surface may include a sharp electrode. Additionally or alternatively, the electrically conductive surface may include a dull electrode.

The method 401 may further include flowing air past the electrically conductive surface at a velocity higher than a flame front velocity absent the electric charge or voltage transmission.

Referring to step 406, according to various embodiments, applying the voltage waveform to the ignited fuel with the electrode may include applying a time-varying voltage to the electrode. Additionally or alternatively, applying the voltage waveform to the ignited fuel with the electrode may include applying an alternating current voltage to the electrode. Applying the time-varying voltage waveform to the ignited fuel with the electrode in step 406 may include applying a periodic voltage waveform having a 0.5 Hertz to 10,000 Hertz frequency. According to an embodiment, applying the time-varying voltage waveform to the ignited fuel with the electrode includes applying a periodic voltage waveform having a 200 to 800 Hertz frequency. Applying the time-varying voltage waveform to the ignited fuel with the electrode may include applying a square waveform, sine waveform, triangular waveform, truncated triangular waveform, sawtooth waveform, logarithmic waveform, asymmetric waveform, exponential waveform, etc. Applying the time-varying voltage waveform to the ignited fuel with the electrode may include applying a waveform having ±1000 volts to ±115,000 volts amplitude. According to an embodiment, applying the time-varying voltage waveform to the ignited fuel with the electrode may include applying a waveform having ±8000 volts to ±40,000 volts amplitude.

While the illustrative voltages described herein correspond to conventionally available voltages, another way to look at the applied voltage is to specify electrical field strength. At normal atmospheric pressure, dielectric breakdown can occur at about 25,000 volts per inch. According to embodiments, flame holding occurs when the voltage travels through the fuel stream or mixed air and fuel stream rather than by dielectric breakdown through air. According to embodiments, the voltage difference between an electrode applying electrical charge to the exothermic reaction and the conductive surface is maintained below dielectric breakdown voltage. For example, it can be desirable to maintain a field strength of less than 25,000 volts per inch (or higher, at higher combustion pressures) between the electrode and the conductive surface. For example, in a combustion system with 8 inches of separation between the electrode and the conductive surface, a voltage difference of 200,000 volts or lower will provide a field strength below dielectric breakdown voltage, and the system may operate as described herein.

According to an embodiment, the method 401 includes holding the electrically conductive surface at a voltage different than the voltage applied to the electrode. For example, embodiments that include applying a time-varying voltage waveform to the ignited fuel may also include applying a second time-varying voltage to the electrically conductive surface, and may further include applying a second time-varying voltage being opposite in sign to the time varying voltage applied to the electrode. Alternatively, the electrically conductive surface may be held substantially at voltage ground. According to another embodiment, the method 401 includes electrically isolating the electrically conductive surface from ground and from voltages other than the voltage applied to the electrode. Such isolation may obviate the need to “hold” the electrically conductive surface at a voltage.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A high velocity combustor, comprising:
an electrically conductive surface configured to be adjacent to or within a fuel jet; and
an electrode configured for interaction with an exothermic reaction supported by the fuel jet, configured to apply a voltage or charge to the exothermic reaction, and configured to cause the exothermic reaction to anchor to the electrically conductive
wherein the electrode and the electrically conductive surface are configured for placement in a high velocity gas stream having a velocity greater than the flame propagation velocity along the fuel jet absent the electrode and the electrically conductive surface.

2. The high velocity combustor of claim 1, wherein the exothermic reaction includes combustion of the fuel.

3. The high velocity combustor of claim 1, wherein the exothermic reaction includes a flame.

4. The high velocity combustor of claim 1, wherein the electrode and the electrically conductive surface are configured to cooperate to cause the exothermic reaction to anchor to the electrically conductive surface when a velocity of the fuel jet is greater than a flame propagation velocity in the fuel jet absent the electrode and the electrically conductive surface.

5. The high velocity combustor of claim 1, further comprising:
a fuel nozzle configured to form the fuel jet.

6. The high velocity combustor of claim 5, wherein the electrically conductive surface comprises at least a portion of the fuel nozzle.

7. The high velocity combustor of claim 5, wherein the fuel nozzle is electrically conductive; and further comprising:
an electrical connection configured to keep the electrically conductive surface and the fuel nozzle in electrical continuity with one another.

8. The high velocity combustor of claim 5, wherein the electrically conductive surface is separated from the fuel nozzle and in at least intermittent contact with the fuel jet.

9. The high velocity combustor of claim 1, wherein the electrode is configured to cause plasma emissions to form along a portion of the fuel jet between the electrode and the electrically conductive surface.

10. The high velocity combustor of claim 9, wherein the plasma emissions continuously ignite the exothermic reaction.

11. The high velocity combustor of claim 1, wherein the electrode is configured to cause a luminous emission along a portion of the fuel jet between the electrode and the electrically conductive surface.

12. The high velocity combustor of claim 11, wherein the luminous emission is associated with ignition of the exothermic reaction.

13. (canceled)

14. The high velocity combustor of claim 1, wherein the voltage includes an alternating current voltage.

15. The high velocity combustor of claim 1, further comprising:
a voltage source configured to apply a time-varying voltage to the electrode.

16. The high velocity combustor of claim 15, wherein the time-varying voltage includes a periodic voltage waveform having a 50 to 10,000 Hertz frequency.

17. The high velocity combustor of claim 16, wherein the time-varying voltage includes a periodic voltage waveform having a 200 to 800 Hertz frequency.

18. The high velocity combustor of claim 15, wherein the time-varying voltage includes a square waveform, sine waveform, triangular waveform, truncated triangular waveform, sawtooth waveform, logarithmic waveform, or exponential waveform.

19. The high velocity combustor of claim 15, wherein the time-varying voltage includes a waveform having ±1000 volt to ±115,000 volt amplitude.

20. The high velocity combustor of claim 19, wherein the time-varying voltage includes a waveform having ±8000 volt to ±40,000 volt amplitude.

21. The high velocity combustor of claim 15, wherein the voltage source is configured to hold the electrically conductive surface at a voltage different than the voltage applied to the electrode.

22. The high velocity combustor of claim 15, wherein the voltage source is configured to apply a second time-varying voltage to the electrically conductive surface, the second time-varying voltage being opposite in sign to the time-varying voltage applied to the electrode.

23. The high velocity combustor of claim 1, wherein the electrically conductive surface is held substantially at voltage ground.

24. The high velocity combustor of claim 1, wherein the electrically conductive surface is electrically isolated from ground and from voltages other than the voltage applied to the electrode.

25. The high velocity combustor of claim 1, wherein the electrode includes a dull electrode.

26. The high velocity combustor of claim 1, wherein the electrode includes a sharp electrode.

27. The high velocity combustor of claim 1, wherein the electrically conductive surface comprises a dull second electrode.

28. The high velocity combustor of claim 1, wherein the electrically conductive surface comprises a sharp second electrode.

29. The high velocity combustor of claim 1, wherein the combustor includes a terrestrial or aviation turbine combustor.

30. The high velocity combustor of claim 29, further comprising:
a turbine stage configured to receive high velocity, hot gas from the combustor.

31. The high velocity combustor of claim 30, wherein the terrestrial turbine does not include a topping apparatus.

32. The high velocity combustor of claim 29, wherein the terrestrial or aviation turbine includes a combustor having smaller size than a combustor not including the electrode and electrically conductive surface.

33. The high velocity combustor of claim 1, wherein the electrode is positioned for at least intermittent contact with the exothermic reaction.

34.-37. (canceled)

38. The method for operating a high velocity combustor of claim 88, further comprising:
anchoring the ignition to the electrically conductive surface while the luminous state in the fuel jet is maintained.

39.-43. (canceled)

44. The method for operating a high velocity combustor of claim 85, wherein the electrode includes a sharp electrode.

45. The method for operating a high velocity combustor of claim 85, wherein the electrode includes a dull electrode.

46.-55. (canceled)

56. The method for operating a high velocity combustor of claim 101, further comprising:
holding the electrically conductive surface at a voltage different than the voltage applied to the electrode.

57. The method for operating a high velocity combustor of claim 56, further comprising:
applying a second time-varying voltage to the electrically conductive surface, the second time-varying voltage being opposite in sign to the time varying voltage applied to the electrode.

58. The method for operating a high velocity combustor of claim 85, further comprising:
holding the electrically conductive surface substantially at voltage ground.

59. The method for operating a high velocity combustor of claim 85, further comprising:
electrically isolating the electrically conductive surface from ground and from voltages other than the voltage applied to the electrode.

60.-61. (canceled)

62. The device of claim 5, wherein the fuel nozzle is electrically conductive; and further comprising:
an electrical connection configured to keep the electrically conductive surface and the fuel nozzle in electrical continuity with one another.

63. The device of claim 5, wherein the electrically conductive surface is electrically isolated from the fuel nozzle.

64. The device of claim 5, wherein the electrically conductive surface is a surface of the nozzle.

65. The device of claim 1, comprising a voltage source operatively coupled to the electrode and the electrically conductive surface, configured to apply a voltage difference between the electrode and the electrically conductive surface.

66.-71. (canceled)

72. The device of claim 65, wherein the voltage source is configured to apply a voltage signal generating an electric field of less than a breakdown voltage of the surrounding fluid.

73.-84. (canceled)

85. A method for operating a high velocity combustor, comprising:
emitting a jet of fuel from a nozzle at a velocity greater than the flame propagation velocity along the jet of fuel;
igniting the fuel; and
applying a voltage potential to the jet of fuel, including the ignited fuel, between an electrode location distal from the nozzle and an electrically conductive surface located proximate to the nozzle.

86. The method for operating a high velocity combustor of claim 85, further comprising:
exciting a plasma state in the fuel jet with the applied voltage potential.

87. The method for operating a high velocity combustor of claim 86, further comprising:
maintaining fuel ignition with the plasma state.

88. The method of claim 85, further comprising:
creating a luminous state in the fuel jet with the applied voltage potential.

89. The method for operating a high velocity combustor of claim 85, further comprising:
anchoring the fuel ignition to the electrically conductive surface by applying the voltage potential.

90. The method for operating a high velocity combustor of claim 85, further comprising:
maintaining a flame front near the electrically conductive surface by applying the voltage potential.

91. The method for operating a high velocity combustor of claim 85, comprising increasing a velocity of a flame front of combustion of the jet of fuel by applying the voltage potential.

92. The method for operating a high velocity combustor of claim 85, further comprising:
while applying the voltage potential, increasing a flow rate of the jet of fuel to exceed a fuel jet velocity at which flame blow-off occurs absent the applied voltage potential.

93. The method for operating a high velocity combustor of claim 85, further comprising:
driving a turbine with gas heated by the ignited fuel.

94. The method for operating a high velocity combustor of claim 85, further comprising:
heating an industrial process with the ignited fuel.

95.-96. (canceled)

97. The method for operating a high velocity combustor of claim 85, wherein the electrically conductive surface includes a sharp electrode.

98. The method for operating a high velocity combustor of claim 85, wherein the electrically conductive surface includes a dull electrode.

99. The method for operating a high velocity combustor of claim 85, further comprising:
flowing air past the electrically conductive surface at a velocity higher than a flame front velocity in the jet of fuel absent the applied voltage potential.

100. The method for operating a high velocity combustor of claim 85, wherein the applying a voltage potential includes applying an alternating current voltage potential.

101. The method for operating a high velocity combustor of claim 85, wherein the applying a voltage potential includes applying a time-varying voltage waveform.

102. The method for operating a high velocity combustor of claim 101, wherein the applying a time-varying voltage waveform includes applying a periodic voltage waveform having a frequency of between about 50 and 10,000 Hertz.

103. The method for operating a high velocity combustor of claim 102, wherein the applying a time-varying voltage waveform includes applying a periodic voltage waveform having a frequency of between about 200 and 800 Hertz.

104. The method for operating a high velocity combustor of claim 101, wherein the applying a time-varying voltage waveform includes applying one of a: square waveform, sine waveform, triangular waveform, truncated triangular waveform, sawtooth waveform, logarithmic waveform, asymmetric waveform, or exponential waveform.

105. The method for operating a high velocity combustor of claim 101, wherein the applying a time-varying voltage waveform includes applying a waveform having an amplitude of between about ±1000 volts and ±115,000 volts.

106. The method for operating a high velocity combustor of claim 105, wherein the applying a time-varying voltage waveform includes applying a waveform having an amplitude of between about ±8000 volts and ±40,000 volts.

107. The method for operating a high velocity combustor of claim 85, further comprising:
holding the electrically conductive surface substantially at voltage ground.

108. The method for operating a high velocity combustor of claim 85, further comprising:
electrically isolating the voltage potential applied to the jet of fuel from ground.
